(19) United States
(12) Patent Application Publication
(10) Pub. No.: US 2004/0204042 A1
(43) Pub. Date: Oct. 14, 2004

(54) Portable audio device

(75) Inventors: Philip I. Neaves, Sittingbourne (GB); Matthew J. Bickerton, Blechingley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 09/878,297

(22) Filed: Jun. 11, 2001

(30) Foreign Application Priority Data
Jun. 12, 2000 (GB) 0014330.5

(51) Int. Cl. H04M 1/00

(52) U.S. Cl. 455/556.1; 455/347; 455/66.1; 455/550.1

(57) ABSTRACT

Personal audio relay apparatus includes a mobile telephone and a portable audio signal source device such as an MP3 player. Once a telephone call has been established a user can operate the control means causing the telephone to receive at telephone input audio programme material over line from the audio source. This allows the remote party at the other end of the telephone call to hear the audio programme. As well as allowing music to be shared the arrangement serves to provide music to the remote party when they are placed on ‘hold’ thereby allowing a party to know that the call has not been terminated. During this time, audio input from the normal telephone microphone may be muted.

The present invention relates to portable audio equipment and particularly, but not exclusively to such equipment having telecommunications capability.

Mobile telecommunications apparatus is now an everyday part of many people's lives. As the adoption of mobile telephones has become more widespread these devices are often being used to make social calls and not just for business communications. Some telecommunication service providers offer packages which include low cost or tariff free call time which further encourages the activity of making social calls.

People who travel will often carry a mobile telephone and a portable audio device such as a cassette player or compact disc player. People often share a taste in music and the task of trying to describe a newly acquired sound recording to a friend can be difficult. It is much easier just to play the recording to them. However, when doing this over the telephone using conventional portable audio reproduction devices the requirement to hold the audio source (headphones or loudspeakers) against the telephone mouthpiece results in a catastrophic loss in sound quality. Because this approach necessitates the transmittal of audio over the air interface from the audio device speaker to the telephone pick-up transducer, loss of sound quality is even more severe if there is background environmental noise.

It is an object of the present invention to provide an arrangement which allows the transmittal of audio over a telecommunications link while minimising the loss of sound quality while doing so.

In accordance with the present invention there is provided a personal audio relay apparatus comprising:

a mobile telecommunications device for supporting a telecommunications link and having at least one input;

a portable audio signal source device having at least one output; and

control means,

wherein said mobile telecommunication device and said audio signal source are responsive to the control means to establish a signal path between the at least one output of the audio signal source and the at least one input of the telecommunications device to relay audio signals from the audio source device over a telecommunications link.

Thus by directly connecting together the output of the audio signal source device with the input of the telecommunication device the sound quality of the audio programme material deteriorates to a lesser extent than would be the case using similar apparatus but not benefiting from the present invention.

In one arrangement the at least one output of the audio signal source device provides audio signals in an analogue format and said at least one input of the telecommunications device receives said signals in the said analogue format. In another arrangement the at least one output of the audio signal source device provides audio signals in a digital format and said at least one input of the telecommunications device receives said signals in the said digital format.

The mobile telecommunications device and portable audio signal source device may be integrated.

Further features of the present invention are recited in the attached claims to which reference should now be made and the disclosure of which is incorporated herein by reference.

The present invention will now be described by way of example only with reference to the Figures of the accompanying drawings in which:

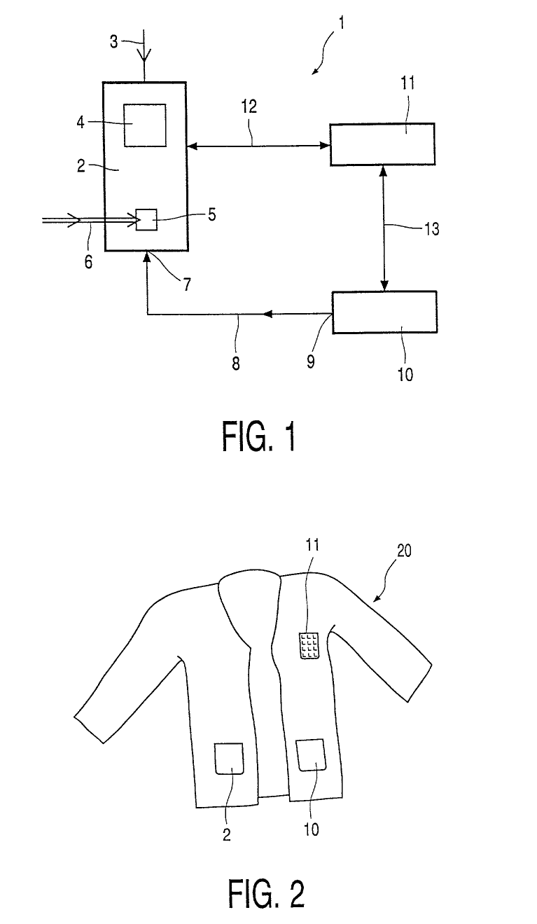

FIG. 1 is a schematic representation of components of the present invention; and

FIG. 2 shows a garment incorporating the apparatus of the present invention.

With reference to FIG. 1, personal audio relay apparatus 1 is provided in the form of a mobile telephone 2 having an antenna 3. The mobile telephone is provided with an audio output transducer 4 for the user to listen to when making a telephone call and an audio input transducer 5 for the user to speak into when making a telephone call, and the user voice input is represented by reference numeral 6. The mobile telephone is also provided with a further input 7 which is connected via line 8 to an audio output 9 of a portable audio signal source device 10. Control means 11 is connected to the mobile telephone 2 and audio reproduction means 10 by control lines 12 and 13 respectively to control the operation of the telephone 2 and signal source device 10.

Once a user has established a telephone call using the telephone 2, the apparatus is configurable in response to the control means 11 at the command of the user to route the output of the audio signal source device 10 over the telecommunications network via the telephone 2. This is performed by the user operating the control means 11 which generates a command on control line 12 instructing the telephone 2 to accept audio programme material provided at input 7 via line 8 and to transmit the audio programme via antenna 3 over the telecommunication network to the destination. Thus the programme material may be reproduced at the remote end of the telecommunications link. Alternatively, once a user has established a telephone call using the telephone 2, activating the audio signal source 10 to cause reproduction of audio programme material causes a control signal to be sent over control line 13 to the control means which then instructs the telephone 2 over control line 12 to accept audio programme material provided at input 7 via line 8.

While the telephone 2 is accepting audio programme material at input 7 via line 8, signals from the audio input transducer 5 of the telephone may be muted. Alternatively signals from the input 7 and the audio transducer 5 may be combined and relayed over the telecommunications network, as will be appreciated by the person skilled in the art.

The control means 11 may be an integral part of the telecommunications apparatus 2 or the audio signal source device 10. Indeed the telecommunications apparatus 2 and audio signal source device 10 may be an integral device or system.

The present arrangement allows people to share music over a telecommunications link. However, the arrangement also allows one party to the telephone conversion to put the other party on ‘hold’ and at the same time relay music to the latter party which has the advantage of indicating to the remote party that the call has not been terminated.

The audio signal source device 10 can be one of a number of equipment types including a cassette player, radio receiver, compact disc player, mini-disc or so called MP3 player.

Where the programme material is provided to the input 7 of the telecommunications apparatus 2 in an analogue format, it will be transmitted by the telecommunications apparatus as a normal voice call and therefore can be listened to at the remote end using a normal telephone receiving equipment.

Where the programme material is stored in digital format, it may be provided to the input 7 of the telecommunications apparatus 2 in either an analogue or digital format. Where an analogue format is employed the situation will be as mentioned in the above paragraph. Where a digital format is employed there are further possibilities for operation as it will be possible in some arrangements to transmit the programme material over the telephone link digitally for instantaneous, near instantaneous or subsequent reproduction at the remote end of the link. Such an arrangement would require remote apparatus capable of decoding and reproducing such digital information, such as an MP3 decoder or the like. This arrangement has the potential to offer improved audio quality at the remote end of the telecommunications link.

With reference to FIG. 2 the personal audio relay apparatus 1 may be integrated either wholly or partly with a garment 20. Garment 20 is provided with pockets, connectors or the like for receiving the audio relay apparatus 1 of the present invention. In the arrangement shown the apparatus is distributed with the telephone 2, audio signal source device 10 and control means 11 provided as separate components. The control means 11 is provided with a keypad for the user to operate the apparatus. The garment 20 is provided with integral wiring (not shown) and connectors (not shown) to connect the telephone 2, audio signal source device 10 and control means 11 together. Preferably the connectors allow the equipment to be attached and removed from the garment easily for cleaning of the garment, exchange of equipment components and use of the equipment components either separately or with other garments.

From reading the present disclosure other modifications will be apparent to the person skilled in the art. Such modifications may involve other features which are already known in the design, manufacture and use of systems and devices and component parts thereof and which may be used instead of or in addition to features already described herein.

1. Personal audio relay apparatus comprising:
a mobile telecommunications device for supporting a telecommunications link and having at least one input;
a portable audio signal source device having at least one output; and
control means,
wherein said mobile telecommunication device and said audio signal source are responsive to the control means to establish a signal path between the at least one output of the audio signal source and the at least one input of the telecommunications device to relay audio signals from the audio source device over a telecommunications link.

2. The apparatus of claim 1 wherein said at least one output of the audio signal source device provides audio signals in an analogue format and said at least one input of the telecommunications device receives said signals in the said analogue format.

3. The apparatus of claim 1 wherein said at least one output of the audio signal source device provides audio signals in a digital format and said at least one input of the telecommunications device receives said signals in the said digital format.

4. The apparatus of claim 3 wherein said audio signal source device is an MP3 player.

5. The apparatus of claim 1 wherein the said mobile telecommunications device is a portable telephone.

6. The apparatus of claim 1 wherein the mobile telecommunications and portable audio signal source devices are integrated.

7. The apparatus of claim 1 wherein said control means is integrated with one of said mobile telecommunications device or said portable audio signal source and connectable to the other thereof.

8. The apparatus of claim 1 further comprising user operable input means by which the control means is operable under user command.

9. The apparatus of claim 1 wherein said control means establishes said signal path when an audio signal is detected at the source device at least one output.

10. The apparatus of claim 1 wherein the mobile telecommunications device is provided with an audio input transducer for generating an electrical output signal and said output signal is muted when said control means establishes said signal path.

11. A garment featuring the personal audio relay apparatus of claim 1.

12. The garment of claim 11 and further comprising an integrated interconnect arrangement for connecting components of the personal audio relay apparatus.
